(19) United States
(12) Patent Application Publication
(10) Pub. No.: US 2018/0225794 A1
(43) Pub. Date: Aug. 9, 2018

(54) S.O.S Save our Students

(71) Applicant: Myisha Lavonne Boulware, Aurora, IL (US)

(72) Inventor: Myisha Lavonne Boulware, Aurora, IL (US)

(21) Appl. No.: 15/425,060

(22) Filed: Feb. 6, 2017

(51) Int. Cl. G06Q 50/26; G06Q 10/10; H04W 4/20

(52) U.S. Cl. CPC G06Q 50/265; H04L 63/083; H04W 4/206; G06Q 10/10

(57) ABSTRACT

My invention is a mobile app that is downloaded to the user's cellular or electronic device. A student downloads the app, along with designated faculty members in the school setting. Each student and faculty member can create their own personal username with a password. The student can communicate with faculty members anonymously to report a bully, report someone being bullied, or seek help themselves if they are bullied. My invention allows students to report bullying anonymously to designated faculty members chosen by the school.

My invention (S.O.S Save Our Students) is a mobile app that is downloaded to the user's cellular or electronic device. A student downloads the app, along with designated faculty members in the school setting. Each student and faculty member can create their own personal username with a password. The student can communicate with faculty members anonymously to report a bully, report someone being bullied, or seek help themselves if they are bullied. My invention allows students to report bullying anonymously to designated faculty members chosen by the school. The faculty members share their username with the entire school, but the students do not share their chosen username with anyone.

The mobile app is created using a chat feature inside that app that allows the student to have a private one on one conversation with a faculty member of their choice. The students can create an anonymous username that does not reference their legal name. There is also an option within the app for students looking for resources to help them with their situation of being targeted by a bully, witnessing a peer being bullied, or to stand up to a bully themselves.

1. My invention (S.O.S Save Our Students) is a mobile app that is downloaded to the user's cellular or electronic device. A student downloads the app, along with designated faculty members in the school setting. Each student and faculty member can create their own personal username with a password. The student can communicate with faculty members anonymously to report a bully, report someone being bullied, or seek help themselves if they are bullied. My invention allows students to report bullying anonymously to designated faculty members chosen by the school. The faculty members share their username with the entire school, but the students do not share their chosen username with anyone.
The mobile app is created using a chat feature inside that app that allows the student to have a private one on one conversation with a faculty member of their choice. The students can create an anonymous username that does not reference their legal name. There is also an option within the app for students looking for resources to help them with their situation of being targeted by a bully, witnessing a peer being bullied, or to stand up to a bully themselves.
The app can also be used by the student to report illegal or suspicious activity on school grounds. My mobile app helps students feel safer going to school. My mobile app prevents children from feeling as though they would rather commit suicide than continue being bullied at school. My mobile app gives students a voice and the ability to report bullying without the fear of being chastised by their peers.
